(19) United States
(12) Patent Application Publication
(10) Pub. No.: US 2008/0041837 A1
(43) Pub. Date: Feb. 21, 2008

(54) Heating Radiator Incorporating a Tv

(76) Inventor: Alastair Benn, Herts (GB)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 10/597,827

(22) PCT Filed: Feb. 10, 2005
(86) PCT No.: PCT/GB05/00456

§ 371 Date: May 18, 2007

(30) Foreign Application Priority Data
Feb. 11, 2004 (GB) 0402928.6

(51) Int. Cl. H05B 1/00

(52) U.S. Cl. 219/209

(57) ABSTRACT

A heating radiator (17), particularly for installation in a incorporates a TV (9) or similar media/audio-visual/audio or visual display device with either built in, or separate speakers.

### FIELD OF THE INVENTION

This invention relates to a heating radiator/towel rail.

### BACKGROUND OF THE INVENTION

The trend to extend image and/or information display systems to bathrooms, particularly hotel bathrooms is indicated by proposals such as PCT/GB02/02944 to inset a TV monitor into a bathroom wall, and EP 1168285 to incorporate a TV monitor into a mirror. Both involve substantial structural work and possibly re-tiling or re-decorating resulting in heavy installation costs and non-availability of the hotel room until completion.

### OBJECT OF THE INVENTION

A basic object of the invention is the provision of an improved heating radiator/towel rail.

### SUMMARY OF THE INVENTION

According to the present invention, there is provided a heating radiator or towel rail, particularly for installation in a bathroom such as a hotel bathroom, incorporating a TV or similar media/audio-visual/audio or visual display device with either built in, or separate speakers.

### ADVANTAGES OF THE INVENTION

The heating radiator/towel rail in accordance with the invention permits simple installation eg into an existing bathroom rather than the need for any major building works. However, the radiator/towel rail could equally well be installed in a kitchen or any other room, either residential, commercial or industrial.

### PREFERRED OR OPTIONAL FEATURES OF THE INVENTION

The radiator/towel rail is heatable electrically.

The radiator/towel rail is adapted to be connected to a (water filled) central heating system and hence is of any industry-standard radiator/towel rail length to enable use to be made of existing piping/connections with minimal plumbing work.

The TV or similar device is inset into the radiator/towel rail, such that the TV is flush, or substantially so, with a surface of the radiator/towel rail.

The TV or similar device is surface mounted onto, or into, the radiator/towel rail.

The TV or similar device, is attached to a back box.

Speakers and power supply means are also attached to the back box.

A cable entry/exit hole is provided in the back box.

The back box is of stainless steel or other non-rusting material.

An open front of the back box is closed off by a glass screen.

The engagement of the glass screen and the back box is in a water and vapour sealing manner.

A mirror vision film is located over an inner surface of the glass screen.

A black p.v.c. layer, with an aperture appropriate to the size of the TV screen, is located at the inner surface of the mirror vision film.

The back box is fixed to a frame portion of the radiator/towel rail.

The TV or similar device is remotely controlled.

The TV or similar device is provided with manual buttons/knobs.

The buttons/knobs are remotely mounted.

The TV or similar device is controlled by an external source e.g. computer.

The TV or similar device is controlled by some form of touch sensor.

The radiator/towel rail unit is IP rated to enable it to be moisture resistant or even waterproof.

The radiator/towel rail incorporates a mirror.

The radiator/towel rail utilises the “mirror vision” principle of a two-way mirror covering the screen, looking like a conventional mirror when the media type is switched off, but being viewable through when the media type is switched on.

### DRAWINGS

Examples of radiator/towel rail are shown in the accompanying drawing(s), in which:

FIG. 1 is a front elevation of a towel rail in accordance with the invention;

FIG. 2 is a front elevation of a first embodiment of radiator in accordance with the invention;

FIG. 3 is a front elevation of a second embodiment of radiator in accordance with the invention;

FIGS. 4, 5 and 6 are respectively front, side and plan views of a first embodiment of box to receive the TV components;

FIGS. 7, 8 and 9 correspond to FIGS. 4, 5 and 6 but show a second embodiment of box; and

FIG. 10 is an exploded view of the array of components of the TV part of the towel rail/radiator in accordance with the invention.

In all embodiments, like components are accorded like reference numerals.

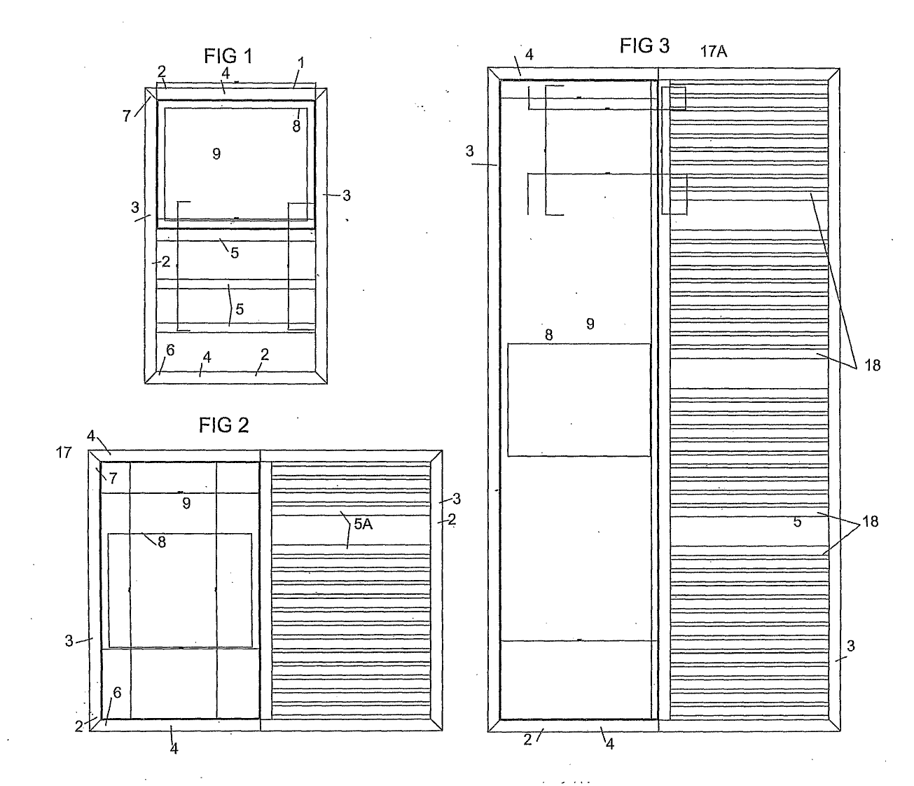

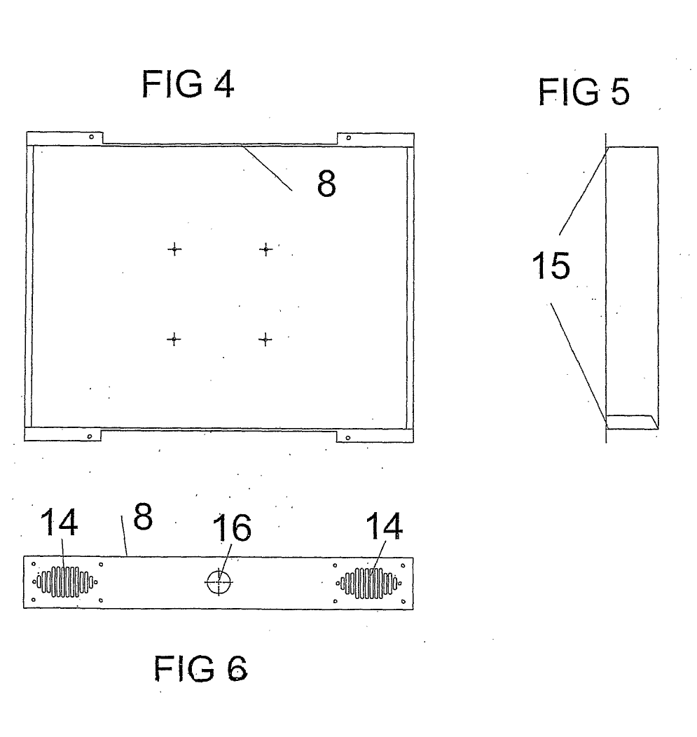

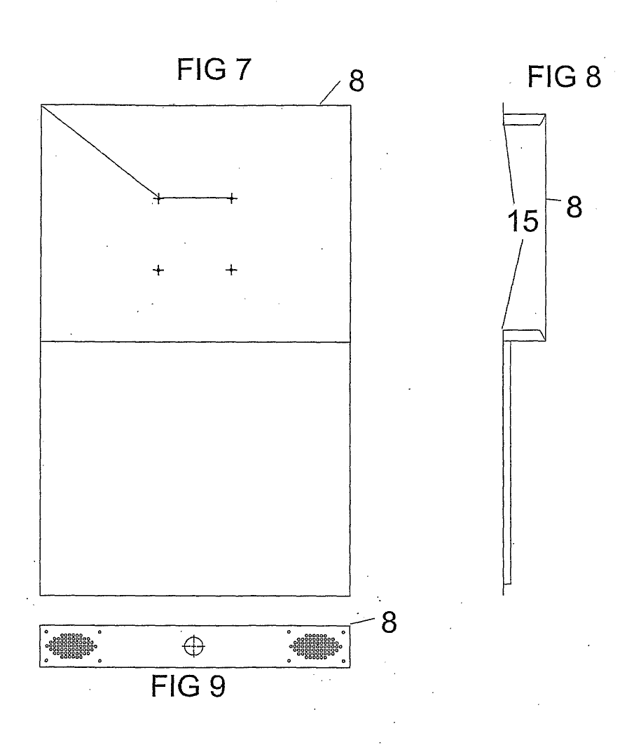

In FIG. 1 is shown a towel rail I comprising a rectangular frame 2 made up of two vertical tubes 3 and two horizontal tubes 4, preferably of stainless steel, with three transverse heating tubes 5. All the tubes are interconnected so as to permit the flow of hot water of a conventional central heating system, a lower hot water inlet connection being indicated at 6 and an upper hot water outlet connection being indicated at 7. In a rectangular space defined between the uppermost transverse tube 5 and the upper horizontal tube 4 is an open fronted box 8, as detailed in FIGS. 4-6. The box 8 is a simple stainless steel fabrication of suitable dimensions.

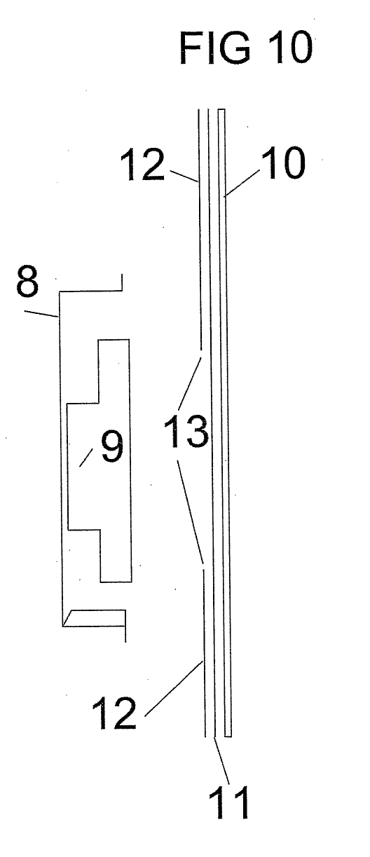

As illustrated in FIG. 10, a conventional LCD TV 9 is fitted to the box 8, whilst the initially open front of the box 8 is closed off by a glass screen 10 behind which is a “mirror vision” film 11, behind which is a black PVC layer 12 with a cut-out viewing window 13 corresponding to the area of the TV 9. As the towel rail in particular is intended for location in a damp environment, suitable waterproof sealants and/or finishes are required to prevent ingress of water vapour, droplets etc into the interior of the box 8, which finishes and seals are known in the industry.

The box 8 also houses speakers 14 and a power supply, whilst a flange 15 of the box 8 is provided with a cable exit hole 16.

FIG. 2 illustrates a heating radiator 17, again having a rectangular frame 2, but with multiple vertically arranged heating tubes 5A located at the upper end of the radiator 14, with the TV 9 located beneath the tubes 4. Water inlet and outlet connections are again illustrated at 6 and 7.

FIG. 3 illustrates an alternative radiator 17A, in which there are four arrays 18 of multiple, vertically arranged heating tubes 5, with the TV 9 located, in contrast to FIG. 2, at the upper end of the radiator.

1. A heating radiator or towel rail, particularly for installation in a bathroom such as a hotel bathroom, incorporating a TV or similar media/audio-visual/audio or visual display device with either built in, or separate speakers.

2. A heating radiator or towel rail as claimed in claim 1, wherein the radiator/towel rail is heatable electrically.

3. A heating radiator or towel rail as claimed in claim 1 or claim 2, wherein the radiator/towel rail is adapted to be connected to a (water filled) central heating system and hence is of any industry-standard radiator/towel rail length to enable use to be made of existing piping/connections with minimal plumbing work.

4. A heating radiator or towel rail as claimed in claim 1, wherein the TV or similar device is inset into the radiator/towel rail, such that the TV is flush, or substantially so, with a surface of the radiator/towel rail.

5. A heating radiator or towel rail as claimed in claim 1, wherein the TV or similar device is surface mounted onto, or into, the radiator/towel rail.

6. A heating radiator or towel rail as claimed in claim 1, wherein the TV or similar device, is attached to a back box.

7. A heating radiator or towel rail as claimed in claim 6, wherein speakers and power supply means are also attached to the back box.

8. A heating radiator or towel rail as claimed in claim 6 wherein a cable entry/exit hole is provided in the back box.

9. A heating radiator or towel rail as claimed in claim 6, wherein the back box is of stainless steel or other non-rusting material.

10. A heating radiator or towel rail as claimed in claim 6, wherein an open front of the back box is closed off by a glass screen.

11. A heating radiator or towel rail as claimed in claim 6, wherein the engagement of the glass screen and the back box is in a water and vapour sealing manner.

12. A heating radiator or towel rail as claimed in claim 6, wherein a mirror vision film is located over an inner surface of the glass screen.

13. A heating radiator or towel rail as claimed in claim 12, wherein a black p.v.c. layer, with an aperture appropriate to the size of the TV screen, is located at the inner surface of the mirror vision film.

14. A heating radiator or towel rail as claimed in claim 6, wherein the back box is fixed to a frame portion of the radiator/towel rail.

15. A heating radiator or towel rail as claimed in claim 1, wherein the TV or similar device is remotely controlled.

16. A heating radiator or towel rail as claimed in claim 1, wherein the TV or similar device is provided with manual buttons/knobs.

17. A heating radiator or towel rail as claimed in claim 16, wherein the buttons/knobs are remotely mounted.

18. A heating radiator or towel rail as claimed in claim 1, wherein the TV or similar device is controlled by an external source e.g. computer.

19. A heating radiator or towel rail as claimed in claim 1, wherein the TV or similar device is controlled by some form of touch sensor.

20. A heating radiator or towel rail as claimed in claim 1, wherein the radiator/towel rail unit is IP rated to enable it to be moisture resistant or even waterproof.

21. A heating radiator or towel rail as claimed in claim 1, wherein the radiator/towel rail incorporates a mirror.

22. A heating radiator or towel rail as claimed in claim 1, wherein the radiator/towel rail utilises the “mirror vision” principle of a two-way mirror covering the screen, looking like a conventional mirror when the media type is switched off, but being viewable through when the media type is switched on.

23. (canceled)
